(19) United States
(12) Patent Application Publication
(10) Pub. No.: US 2024/0169612 A1
(43) Pub. Date: May 23, 2024

(54) GRAPHICS PROCESSING SYSTEMS

(71) Applicant: Arm Limited, Cambridge (GB)

(72) Inventors: Rafal Stepuch, Cambridge (GB); Frank Klaeboe Langtind, Melhus (NO)

(73) Assignee: Arm Limited, Cambridge (GB)

(21) Appl. No.: 18/509,277

(22) Filed: Nov. 14, 2023

(30) Foreign Application Priority Data
Nov. 17, 2022 (GB) 2217227.4

(51) Int. Cl. G06T 11/20; G06T 1/60

(52) U.S. Cl. CPC G06T 11/20; G06T 1/60; G06T 2210/12

(57) ABSTRACT

When processing primitives in a tile-based graphics processing system in which a render output is sub-divided into a plurality of tiles for rendering, before a primitive is written to a primitive list corresponding to a region of the render output, it is first determined whether the primitive can be grouped with one or more previous primitives based on the set of regions of the render output that primitive covers relative to the set of regions of the render output that one or more previous primitives cover. When it is determined that the primitive can be grouped with one or more previous primitives, the primitive is added to a group (i.e. grouped) with the one or more previous primitives. The grouped primitives are then later written together to one or more primitive lists, in a single primitive list write cycle.

### BACKGROUND

The technology described herein relates to a method and apparatus for processing graphics, and in particular to a method and apparatus for use when processing graphics primitives in a tile-based graphics processing system.

Graphics processing is normally carried out by first dividing the graphics processing (render) output to be rendered, such as a frame to be displayed, into a number of similar basic components of geometry to allow the graphics processing operations to be more easily carried out. These basic components of geometry may often be referred to graphics “primitives”, and such “primitives” are usually in the form of simple polygons, such as triangles, points, lines, or groups thereof.

Each primitive (e.g. polygon) is at this stage defined by and represented as a set of vertices. Each vertex for a primitive has associated with it a set of data (such as position, colour, texture and other attributes data) representing the vertex. This “vertex data” is then used, e.g., when rasterising and rendering the primitive(s) to which the vertex relates in order to generate the desired render output of the graphics processing system.

For a given output, e.g. frame to be displayed, to be generated by the graphics processing system, there will typically be a set of vertices defined for the output in question. The primitives to be processed for the output will then be indicated as comprising given vertices in the set of vertices for the graphics processing output being generated.

Once primitives and their vertices have been generated and defined, they can be processed by the graphics processing system, in order to generate the desired graphics processing output (render target), such as a frame for display. This basically involves determining which sampling points of an array of sampling points associated with the render output area to be processed are covered by a primitive, and then determining the appearance each sampling point should have (e.g. in terms of its colour, etc.) to represent the primitive at that sampling point. These processes are commonly referred to as rasterising and rendering, respectively. (The term “rasterisation” is sometimes used to mean both primitive conversion to sample positions and rendering. However, herein “rasterisation” will be used to refer to converting primitive data to sampling point addresses only.)

One form of graphics processing uses so called “tile based” rendering. In tile based rendering, the two dimensional render output (i.e. the output of the rendering process, such as an output frame to be displayed) is rendered as a plurality of smaller area regions, usually referred to as “rendering tiles”. In such arrangements, the render output is typically divided (by area) into regularly sized and shaped rendering tiles (they are usually rectangles, e.g. squares). (Other terms that are commonly used for “tiling” and “tile based” rendering include “chunking” (the rendering tiles are referred to as “chunks”) and “bucket” rendering. The terms “tile” and “tiling” will be used hereinafter for convenience, but it should be understood that these terms are intended to encompass all alternative and equivalent terms and techniques wherein the render output is rendered as a plurality of smaller area regions.)

In a tile based graphics processing pipeline, the geometry (primitives) for the render output being generated is sorted into regions of the render output area, so as to allow the geometry (primitives) that need to be processed for a given region of the render output to be identified. This sorting allows primitives that need to be processed for a given region of the render output to be identified (so as to, e.g., avoid unnecessarily rendering primitives that are not actually present in a region). The sorting process produces lists of primitives to be rendered for different regions of the render output (referred to herein as “primitive” lists but also commonly referred to as “polygon” or “tile” lists).

Once the primitive lists have been prepared for all the render output regions, each rendering tile is processed, by rasterising and rendering the primitives listed for the region of the render output corresponding to the rendering tile.

The process of preparing primitive lists for regions of the render output thus basically involves determining which primitives should be processed for each render output region. This process is usually carried out by determining (at a desired level of accuracy) which regions of the render output each and every primitive that is to be processed intersects with (i.e. will (at least in part) fall within). Once it is determined which regions of the render output a particular primitive falls within, that primitive can then be written to the corresponding primitive list for each of those render output regions. Typically this determination is made using the positions of the vertices of each primitive. Thus, for each primitive to be processed, the graphics processor reads in the associated vertex data, converts the vertex positions at least to screen space (vertex shading), and then determines using the shaded vertex positions for each primitive which region(s) of the render output the primitive at least partially covers (and so should therefore be rendered for).

It should be noted here that where a primitive is determined to fall within more than one render output region, as will frequently be the case, it is included in a primitive list for each region that it falls within. A render output region for which it is to be determined whether a particular primitive falls within (and hence, for which a primitive list is prepared) could be a single rendering tile, or a group of plural rendering tiles, etc.

In effect, each render output region can be considered to have a “bin” (the primitive list) into which any primitive that is found to fall within (i.e. intersect with) the region is placed (and, indeed, the process of sorting the primitives on a region-by-region basis in this manner is commonly referred to as “binning”).

The process of writing primitives to primitive lists (i.e. “bins”) is typically carried out in a primitive-by-primitive manner, with each primitive being written to each of the primitive lists corresponding to each of the regions the primitive falls within in turn. In conventional systems, it takes one primitive list write cycle to write a single primitive to a primitive list. Thus, to write a primitive to each of the primitive lists for each of plural regions it falls within, the (single) primitive will first be written to a first primitive list (corresponding to a first region that the primitive falls within) in a first primitive list write cycle, and then the (single) primitive is written to another primitive list (corresponding to another region that the primitive falls within) in a next primitive list write cycle, etc. and so on, until that (single) primitive has been written to each of the primitive lists corresponding to each of the plural regions the primitive falls within. So if, for example, a primitive is found to fall within four separate regions of the render output (such that it needs to be written to four primitive lists corresponding to those four regions), it will take four separate primitive list write cycles in order to write that primitive to each of the four corresponding primitive lists (in turn).

Once a primitive has been written to each of the primitive lists for each of the region it covers in this manner, then the same process is carried out for a next primitive, with that next primitive being written to each of the primitive lists corresponding to each of the regions it covers in turn, etc. and so on. This process is carried out for each primitive in the sequence of primitives to be processed, thereby building up each of the primitive lists.

The primitive lists prepared in this way can then be written out, e.g., to memory, and once a first processing pass including the tiling operation is complete, such that all of the primitive lists (for all of the primitives for all of render output regions) have been prepared, the primitive lists can then be used by the graphics processor, e.g. in a second (deferred) processing pass, to perform the actual rendering of the rendering tiles, with the information stored in the primitive lists being used accordingly to identify the primitives to be rendered for each rendering tile when generating the desired render output, e.g. frame for display.

The Applicants believe however that there remains scope for improvements in how primitives are written to primitive lists in tile based rendering systems.

### BRIEF DESCRIPTION OF THE DRAWINGS

Various embodiments will now be described by way of example only and with reference to the following figures, in which:

FIG. 1A shows schematically an arrangement of a graphics processing system that can be operated in accordance with the technology described herein;

FIG. 1B shows certain parts of the operation of the graphics processing system of FIG. 1A in further detail;

FIG. 2 shows an example sequence of primitives to be processed in an embodiment of the technology described herein;

FIG. 3 is a flowchart illustrating a method for grouping primitives and writing grouped primitives to primitive lists according to an embodiment of the technology described herein;

FIG. 4 shows a process for grouping primitives of the sequence of primitives shown in FIG. 2, and writing those primitives to primitive lists according to an embodiment of the technology described herein;

FIG. 5 shows a process for grouping primitives of the sequence of primitives shown in FIG. 2, and writing those primitives to primitive lists according to another embodiment of the technology described herein; and

FIG. 6 shows a process for grouping primitives of the sequence of primitives shown in FIG. 2, and writing those primitives to primitive lists according to another embodiment of the technology described herein.

### DETAILED DESCRIPTION

A first embodiment of the technology described herein comprises a method of operating a tile-based graphics processing system in which a render output is sub-divided into a plurality of tiles for rendering, and in which primitives in a sequence of primitives to be processed are written to primitive lists corresponding to respective regions of the render output, the method comprising:
before writing a primitive to a primitive list, first determining whether the primitive can be grouped with one or more previous primitives in the sequence of primitives, for the purposes of being written to one or more primitive lists;
when it is determined that the primitive can be grouped with one or more previous primitives, grouping the primitive with the one or more previous primitives; and thereafter:
writing grouped primitives together to one or more primitive lists.

A second embodiment of the technology described herein comprises a tile-based graphics processing system in which a render output is sub-divided into a plurality of tiles for rendering, and comprising a tiling circuit configured to write primitives in a sequence of primitives to be processed to primitive lists corresponding to respective regions of the render output, wherein the tiling circuit comprises:
a primitive grouping circuit configured to:
before the primitive is written to a primitive list, first determine whether the primitive can be grouped with one or more previous primitives in the sequence of primitives, for the purposes of being written to one or more primitive lists; and
when it is determined that the primitive can be grouped with one or more previous primitives, group the primitive with the one or more previous primitives; and
a primitive list writing circuit configured to write grouped primitives together to one or more primitive lists.

The technology described herein relates to tile-based graphics processing in which primitives are written to primitive lists corresponding to regions of the render output that they are determined to fall within.

Whereas in conventional systems a primitive to be processed would simply be written to each primitive list for each of the regions which it covers in turn (before doing the same for a next primitive to be processed, etc. and so on), in the technology described herein, primitives are “grouped” together for the purposes of being written to primitive lists. Thus, prior to writing a primitive to a primitive list, it is first determined whether or not the primitive can be “grouped” with one or more previous primitives (i.e. earlier primitives in the sequence of primitives to be processed), for example (and as will be discussed below) based on what regions of the render output the primitive falls within in (compared to the regions that one or more previous primitives fall within).

When it determined that such a grouping can be made, then the primitive is “grouped” (i.e. added to a group) with the one or more previous primitives. Primitives that have been grouped together in this way are then later written together to primitive lists. In other words, multiple (grouped) primitives are written to a primitive list that corresponds to a region that they cover, in a single primitive list write cycle.

Thus, in the technology described herein, rather than writing individual primitives to individual primitive lists in turn, primitives can be “grouped” together for the purposes of being written collectively to primitive lists. The Applicants have recognised that this approach is more efficient, since it enables multiple primitives (within the group) to be written to a tile list in a single primitive list write cycle, and hence can lead to a reduction in the overall number of primitive list write cycles required to write primitives to their primitive lists, compared to conventional systems wherein each primitive is individually written to each required primitive list (in individual primitive list write cycles).

The Applicants have further recognised that this benefit in reducing the overall number of primitive list write cycles required to write the primitives to primitive lists can (and often does) outweigh the processing cost associated with determining whether primitives can be grouped together, thereby leading to an overall reduction in the total processing power and/or number of processing cycles required to sort the primitives into their primitive lists.

The technology described herein relates to tile-based graphics processing. The tiles can be any suitable size or shape. The tiles are in an embodiment all the same size and shape, although this is not essential. In embodiments, each tile is rectangular (including square), and in an embodiment 16×16 or 32×32 sampling positions in size.

Similarly, the regions of the render output that the render output is sub-divided into (for the purposes of preparing primitive lists corresponding to those regions) may be any suitable size or shape. The regions can, and in embodiments do, directly correspond to the tiles of the render output (i.e. such that a primitive list is prepared for each tile that the render output is subdivided into). However, this need not necessarily be the case. For example, a region of the render output (for which a primitive list is prepared) could correspond to (i.e. cover) a number (e.g. four) of different (e.g. adjoining) tiles of the render output, or it could correspond to a fraction of a tile (i.e. such that a single tile covers a plurality of regions of the render output for which primitive lists are prepared). The regions for which primitive lists are prepared are in an embodiment all the same size and shape, although this need not necessarily be the case.

In some embodiments, there are one or more sets of regions for which primitive lists can be prepared, with the regions in different sets of regions in an embodiment differing in size (area).

In an embodiment, the sets of regions are arranged in a hierarchy of sets of regions, wherein each set of regions corresponds to a layer in the hierarchy of sets of regions, and wherein regions in progressively higher layers of the hierarchy are progressively larger. Each set of regions (corresponding to a layer in the hierarchy) in an embodiment spans the (entire) render output, such that the render output is effectively overlaid by plural layers of sets of regions (and accordingly wherein regions in different layers in the hierarchy may overlap one another).

In an embodiment, each region for which a primitive list can be prepared in a lowest layer of the hierarchy corresponds to a single tile of the render output, with regions in successively higher layers encompassing progressively more tiles, e.g. corresponding to 2×2 tiles, 4×4 tiles, 8×8 tiles, etc. respectively (or any other suitable and desired increasing region size). Thus, the sets of regions in an embodiment comprise one set of regions in which each region of the set corresponds to a respective single rendering tile, and one or more (and in an embodiment more than one) sets of regions in which each region of the set corresponds to (encompasses) more than one rendering tile.

In an embodiment regions in the same set of regions (same layer of the hierarchy) are the same size and shape (for example, each encompassing the same number of tiles). In an embodiment regions in the same set of regions (same layer of the hierarchy) correspond to different regions of the render output (such that regions in the same set of regions do not overlap).

It will be apparent that, in such arrangements, regions in different sets of regions (different layers of the hierarchy) may encompass the same portion of a render output (albeit at a different resolution), such that a primitive may fall within one or more regions in different layers of the hierarchy (and correspondingly have one or more primitive lists into which it could be written). (Likewise, primitive lists for multiple different regions in different layers of the hierarchy may need to be consulted in order to identify primitives needed to render a tile).

In the technology described herein, before a primitive is written to a primitive list, it is first determined whether or not the primitive can be grouped with one or more previous primitives (i.e. earlier primitives in the sequence of primitives being processed, compared to the present primitive). This determination can be made in any suitable and desired manner, and according to any suitable or desired set of criteria. In an embodiment, it can only be determined possible for the primitive to be grouped with one or more previous primitives when there are one or more such previous primitives available for the primitive to be grouped with, that have also not yet been written to any primitive lists.

In an embodiment, the determination as to whether a primitive can be grouped with one or more previous primitive is made by comparing the primitive with one or more previous primitives, to see if they are sufficiently similar in some way (e.g., and as will be discussed below, based on whether they cover the same or a similar set of regions of the render output). Thus, in embodiments, the method comprises (and correspondingly the system is configured to) determining whether the primitive can be grouped with one or more previous primitives by comparing the primitive to one or more previous primitives.

As discussed above, the purpose of the grouping of the primitives is to enable multiple primitives to be written to primitive lists (corresponding to regions of the render output that multiple primitives are determined to fall within) together (i.e. within a single primitive list write cycle). The Applicants have recognised that it can therefore be beneficial to specifically choose to only group primitives together that cover the same, or (and as will be discussed further below) similar or overlapping sets of regions of the render output, since this may ensure that (multiple, or a higher proportion of) primitives that are grouped together are to be written to the same one or primitive lists, and hence can ultimately be written together to those primitive lists.

Thus, in embodiments, the method comprises (and correspondingly the system is configured to) determining whether the primitive can be grouped with one or more previous primitives based on the region of the render output, and in an embodiment the set of primitive list region(s) of the render output, covered by the primitive relative to the region of the render output, and in an embodiment the set of primitive list region(s) of the render output, covered by one or more previous primitives.

The process of determining what regions of the render output a particular primitive covers (i.e. falls within, or potentially falls within) can be carried out in any suitable or desired manner, and at any suitable and desired level of precision.

For example, the set of regions covered by a particular primitive can be (and in some embodiments, is) determined at a high precision (or “exact”) level by, e.g., directly using the primitive's vertex positions to calculate exactly which regions of the render output the primitive will appear (at least in part) in.

Alternatively, the set of regions covered by a particular primitive can be (and in some embodiments, is) determined at a comparatively lower level of precision, for example by using a so-called “bounding box” technique. In this case, a so called “bounding box” is drawn around a primitive, and then the regions of the render output covered by the bounding box are determined. The primitive is considered to “cover” the set of regions covered by the bounding box (even though, as will be understood, the primitive may not actually fall within all of those regions, e.g. if the bounding box does not sufficiently tightly or precisely surround the primitive). The bounding box can be calculated at any suitable or desired level of resolution. For example, the bounding box could be (and in some embodiments, is) rounded to the size of the regions (e.g. tiles) that the render output is divided into (and for which primitive lists are to be prepared).

Once the set of regions covered by the primitive in question has been determined (according to any desired method, as described above), then this set of regions may be compared to the set of regions (determined to be) covered by one or more previous primitives, in order to determine whether the primitive can be grouped with the one or more previous primitives.

In some embodiments, it is (only) determined that a primitive can be grouped with one or more previous primitives when the set of regions covered by the primitive exactly matches the set of the regions covered by one of (e.g. and in an embodiment each and every one of) those one or more previous primitives. In these embodiments, if the set of regions covered by the primitive does not exactly match the set of primitives covered by at least one of (e.g. and in an embodiment each and every one of) the one or more previous primitives, then it is determined that the primitive in question cannot be grouped with those previous primitives.

In these embodiments, it is determined that the primitive in question cannot be grouped with one or more previous primitives (and, hence, the primitive will not be grouped with one or more previous primitives) when the set of regions covered by the primitive does not (i.e. other than) matches the set of the regions covered by one of (e.g. and in an embodiment each and every one of) those one or more previous primitives.

For example, in one such embodiment, if a primitive has been determined to cover two particular regions of the render output, it is determined that the primitive can only to be grouped with previous one or more primitives if those previous one or more primitives also cover exactly those (same) two regions of the render output. Otherwise, it is determined that the primitive cannot be grouped with those one or more previous primitives.

It should be noted that, in these embodiments, although the set of regions covered by a primitive should exactly match the set of regions covered by the one or more previous primitives for the primitive to be grouped with one or more previous primitives, the method by which the set of regions (for both the primitive in questions and the previous one or more primitives) are determined need not be an “exact”, i.e. high precision, method of determination. For example, it could be, and indeed in some embodiments is, that a “bounding box” method (as described above) is used to determine what set of regions are covered by the primitive in question. In these embodiments, it is determined that the primitive can be grouped with the one or more previous primitives when the set of regions covered by (the bounding box of) the primitive exactly matches the set of regions covered by (the bounding box of) the set of regions covered by the one or more previous primitives.

The Applicants have recognised that only grouping together primitives that are known to cover exactly the same set of regions of the render output can beneficially simplify the grouping process and (as will be discussed further below) reduce the data that is required to be stored and used in order to write primitives from the group to their required primitive lists, as well as simplifying that process of writing primitives to the primitive lists (since all of the primitives in the group will be written to the same set of primitives lists corresponding to the same set of regions, with no deviation in the primitives of the group).

However, as will be understood, having such a stringent requirement (i.e. an exact match of regions covered) between primitives for them to be grouped together in these embodiments may mean that much of the time it will be determined that the primitive in question cannot be grouped with one or previous primitives (since often no such exact match will be present). The Applicants have recognised, therefore, that, in alternative embodiments, it may be beneficial to allow primitives to be grouped together, at least some of which do not cover the exact same set of regions of the render output as one another, but that (as will be discussed further below) cover different sets of regions that are at least sufficiently similar or overlapping to one another. This provides a less stringent requirement for primitives to be grouped together, thereby enabling primitives to be grouped together more often compared to embodiments wherein an exact match of regions covered by primitives is required for a grouping of those primitives to take place, whilst still ensuring that primitives grouped together will cover at least some of the same regions and hence can be written to primitive lists (for the regions they cover in common) together.

Thus, in embodiments, the method comprises (and correspondingly the system is configured to) determining that a primitive can (only) be grouped with one or more primitives when the primitive is determined to cover a set of regions that is sufficiently similar to or overlapping with a set of regions covered by one or more previous primitives. In these embodiments, when the set of regions covered by the primitive is not sufficiently (is other than) similar to or overlapping with a set of regions covered by one or more previous primitives, then it is determined that the primitive in question cannot be grouped with those one or more previous primitives.

In an embodiment, it is determined that the primitive in question cannot be grouped with one or more primitives (and, hence, the primitive will not be grouped with one or more previous primitives) when the set of regions covered by the primitive is not (is other than) sufficiently similar to or overlapping with a set of regions covered by one or more previous primitives.

The determination as to whether the set of regions covered by the primitive is sufficiently similar to or overlaps with the set of regions covered by the set of regions covered by (one or more) previous primitives can be carried out in any suitable and desired manner.

For example, in some arrangements it could be the case that it is determined that the primitive can be grouped with one or more previous primitives if at least one region (of the set of regions) covered by the primitive is the same as at least one region (of the set of regions) covered by one or more previous primitives.

In an embodiment, however, wherein the sets of regions covered by respective primitives is determined using the “bounding box” technique (as described above), it is determined that the primitive in question can be grouped with one or more previous primitives when (the set of regions covered by) the bounding box for the primitive is offset from (the set of regions covered by) the bounding box of one or more previous primitives, when the offset is within some particular, in an embodiment selected, in an embodiment predefined, offset threshold.

In other words, in these embodiments, the bounding box for the primitive in question need not (exactly) match the bounding box of one or more previous primitives for it to be determined that the primitive can be grouped with one or more primitives, but (at least some of, and in an embodiment all of) the edges (i.e. the min and max x and y values) of the bounding box of the primitive should be within a certain maximum allowable offset of (i.e. sufficiently close to) the corresponding edges (i.e. the min and max x and y values) of the bounding box of one or more previous primitives.

This maximum offset threshold can be chosen as desired. In an embodiment, wherein the bounding box of primitives is calculated and rounded to the unit of a (square) tile of the render output, the maximum offset threshold is set at a unit of 1 tile length. Thus, in this embodiment, it is determined that a primitive can be grouped with one or more previous primitives if the edges of the bounding box for the primitive are within one tile length (on either side) of the corresponding edges of the bounding box(es) for one or more previous primitives.

For example, in one such embodiment, if a previous primitive was found to have a bounding box having attributes (xmin, ymin, xmax, ymax) of (0, 0, 1, 1), and the present primitive has a bounding box having corresponding attributes of (1, 0, 1, 1), then it would be determined that the present primitive can be grouped with the previous primitive, since the min and max x and y values of the respective bounding boxes are all within the allowed offset threshold (with the for xmax, ymin and ymax of the two bounding boxes matching exactly, and the xmin of the present primitive bounding box being 1 unit (i.e. within the threshold allowed offset) away from the xmin of the previous primitive bounding box). However, if the present primitive were instead to have a bounding box with coordinates (2, 0, 2, 1), then it would be determined that the primitive could not be grouped with the previous primitive, since the xmin value for the bounding box of the present primitive is 2 units (i.e. over the allowed maximum threshold of 1 unit) away from the corresponding xmin value for the bounding box of the previous primitive.

In another embodiment, it is determined whether or not the set of regions covered by the primitive is sufficiently similar to the set of regions covered by one or more previous primitives based on whether or not (at least some of, and in an embodiment all of, the regions of) the set of regions covered by the primitive are within a “superset” of regions, wherein that “superset” of regions also includes (at least some of, and in an embodiment all of, the regions of) the set of regions covered by a previous primitive.

In other words, in these embodiments, there are one or more “supersets” (e.g. grids) of (e.g. adjoining) regions that are defined, with the set of regions covered by a previous primitive being within a particular superset. It is then determined whether or not to group a primitive with one or more previous primitives based on whether the set of regions covered by the primitive is within that same superset as the set of regions covered by one or more previous primitives.

For example, in one such embodiment, a superset of regions is defined that corresponds to a particular 3×3 grid of regions in a particular part of the render output. A determination is made that a primitive can be grouped with one or more previous primitives if the set of regions covered by the primitive, and the set of regions covered by a previous primitive, both fall within that (same) superset (even if, for example, at least some of the regions of the set of regions covered by the present primitive are not the same as the regions of the set of regions covered by the previous primitive).

As discussed above, the determination as to whether a primitive can be grouped with one or more previous primitives is in an embodiment made by comparing the primitive to one or more previous primitives. The determination as to whether the primitive can be grouped with one or more previous primitives is, in embodiments (and as discussed above), based (at least in part) on the set of regions that are covered by the primitive relative to the set of regions covered by one or more previous primitives. However, this determination could (and in some embodiments does) also or instead (and in an embodiment also) be made based on whether other corresponding features of the primitive and one or more previous primitives are the same (or sufficiently similar (e.g. incrementally different, or within a certain range of one another)). Examples of such features include (but are not limited to), e.g., the variable rate shading (VRS) rate, Primitive ID, Viewport ID, etc.

In some embodiments, it may be determined to (only) allow a primitive to be grouped with one or more previous primitives if all of the primitives have particular features in common (i.e. that are the same or sufficiently similar). Ensuring that there are features in common may allow the primitives, e.g. to be compressed when (later) being written to primitives lists.

The various features of the respective (present) primitive and the one or more previous primitives that should be determined to be the same (or sufficiently similar) for it to be determined that primitive can be grouped with one or more previous primitives can be chosen as desired. For example, in some embodiments, it is only determined that the present primitive can be grouped with one or more previous primitives if (at least some of, and in an embodiment all of) the features of the present primitive (that are being checked) are the same as (or sufficiently similar to) corresponding (at least some of, and in an embodiment all of) the features of one or more previous primitives.

In instances wherein it is being determined whether a primitive can be grouped with a plurality of previous primitives, it could be the case that, in order for it to be determined that the primitive in question can indeed be grouped with that plurality of previous primitives, the feature(s) of the primitive in (e.g. the set of regions covered, VRS rate, etc.) must be determined to be the same as (or sufficiently similar to) the corresponding features of each of those previous primitives. Such a determination could be made by comparing the primitive to each of the previous primitives, .e.g. by comparing the feature(s) of the present primitive to the corresponding features of each of those previous primitives, in turn, with, e.g., it only being determined that the primitive can be grouped with that plurality of primitives if there is a match between the feature(s) of the present primitive and (at least some of, or in an embodiment each of) those previous primitives.

However, in embodiments, when it is being determined whether the primitive in question can be grouped with a plurality of previous primitives, rather than comparing the primitive to each of those previous primitives (e.g. by comparing feature(s) of the primitive in question to corresponding feature(s) of each of the previous primitives), the primitive is compared to only some (e.g. and in an embodiment, only one) of those previous primitives (i.e. the feature(s) of the primitive in question are compared to the corresponding feature(s) relating to only some of (and in an embodiment only one of) the primitives in the plurality of primitives (with the determination as to whether the primitive can be grouped with the plurality of primitives being made on the basis of the comparison)).

In other words, in embodiments, it can be determined that primitive in question can be grouped with a plurality of primitives based on determining that the present primitive's feature(s) matches (or is sufficiently similar to) those corresponding feature(s) of a subset of (e.g. and in some embodiments, only one of) those previous primitives.

In embodiments, the determination as to whether the primitive can be grouped with one or more previous primitives is made by comparing the primitive to an earliest primitive of those one or more previous primitives (i.e. with it being determined that the primitive can be grouped with the plurality of primitives if its features are determined to match (or be sufficiently similar to) that earliest primitive in that plurality of primitives. As will be discussed below, that earliest primitive can be considered to be the primitive that “starts” (and thus defines) the group of primitives going forwards.

The comparison between the primitive and one or more previous primitives (i.e. the comparison between the feature(s) of the present primitive and corresponding feature(s) of one or more previous primitives) can be made in any suitable or desired manner. In an embodiment, the comparison is made by comparing the feature(s) of the present primitive to corresponding feature(s) relating to one or more of the previous primitives that have been stored, e.g. in memory (in association one or more of the previous primitives themselves, as discussed below).

In embodiments, wherein the determination as to whether the primitive can be grouped with one or more previous primitives is made by comparing the primitive to an earliest primitive of those one or more previous primitives (only), the features of the primitive in question are compared to the features relating to that earliest primitive that have been stored. In an embodiment, and as will be further described below, those features relating to the earliest primitive are stored, e.g. in memory, at the time that that earliest primitive “starts” the group (i.e. when the group is first defined).

In embodiments of the technology described herein, there is only one group of previous primitives to which a (next) primitive can (potentially) be added at a given time. Thus, in these embodiments, the step of determining whether a primitive can be grouped with one or more previous primitives comprises determining whether or not the primitive can be grouped with those one or more previous primitives in the (single) group of primitives that is being maintained. When it is determined that the primitive can be grouped with those one or previous primitives in the (single) group of primitives, the primitive is added to the group.

However, this need not necessarily be the case, and it would be possible to have a plurality of different primitive groups to which a (next) primitive can (potentially) be added at a given time. In this case, it could be determined whether or not a particular primitive could be added to any or each of the primitive groups (e.g. in turn). Thus, In this case, the step of determining whether a primitive can be grouped with one or more previous primitives could comprise determining whether or not the primitive can be grouped with one or previous primitives in a first group, and (e.g. if it is determined that the primitive cannot be added to that first group) determining whether or not the primitive can be grouped with one or more (different) previous primitives in a second group, etc. and so on.

In the technology described herein, once it is determined that the (present) primitive can be grouped with one or more previous primitives, the primitive is grouped with those one or more previous primitives. In other words, the primitive is then added to a group with those one or more previous primitives. This can be done in any suitable or desired manner.

In an embodiment, the group of primitives (to which the present primitive is being added) is stored. Thus, after determining that the present primitive can be grouped with one or more previous primitives, the primitive is in an embodiment written to storage alongside those one or more primitives.

The storage (in which the group of primitives is stored) may comprise any suitable and desired storage. The storage may be part of the graphics processing system, or may be separate to the graphics processing system. It may be a dedicated storage for the purpose of storing primitive group data, or it may be part of a storage that is used to store other data in addition to primitive group data. The storage may be any suitable and desired information storage, such as, e.g., a register or registers, a buffer or buffers, a cache or caches, etc.

The group of primitives could be stored in (main) memory whilst the group of primitives is being build up (i.e. whilst primitives are being added to the group of primitives). However, in embodiments, the primitive group data is retained locally to the processing pipeline as pipeline data whilst the group of primitives is being built up. For example, the primitive group data could be stored in one or more registers local to the processing pipeline.

In some embodiments, when it is triggered to write primitives from the group of primitives to one or more primitive lists (as discussed further below), the primitives of the group of primitives are written directly, e.g., from the one or more registers local to the processing pipeline to primitive lists. In this case, building up (and storing of) a new group of primitives in the, e.g., one or more registers local to the processing pipeline is stalled, e.g. until the primitives in the current group of primitives have all been written from the one or more registers local to the processing pipeline to the one or more primitive lists.

In other embodiments, once it is triggered to write primitives from the group of primitives to primitive lists, the primitive group data is written from, e.g., the one or more registers local to the processing pipeline to one or more additional storage elements (such as one or more additional registers or FIFOs), with primitives in the group of primitives then being written from the additional one or more storage elements to the one or more primitive lists. This enables the building up (and storing of) a new group of primitives in the, e.g. one or more registers local to the processing pipeline to begin before (all of) the primitives in previous group of primitives (now stored in the one or more additional storage elements) have been written to primitive lists. As discussed further below, allowing the process of starting (and e.g. building up) a new group to begin before the process of writing out the previous (grouped) primitives has completed is advantageous, since overlapping those two processes may reduce the overall time required to process the sequence of primitives.

When being added to the group of primitives, the primitive is in an embodiment written to the storage along with any other data relating to the primitive that will later be required to process the primitive or subsequent primitives.

For example, in some embodiments, the primitive is written to storage along with any feature(s) of the primitive (e.g. as described above) that may be required, e.g., when comparing a subsequent primitive to the primitive to determine whether the subsequent primitive can be grouped (i.e. added to the group with) the primitive.

In some embodiments, the primitive is written to storage along with data for the primitive which indicates the set of regions covered by the primitive, that will be later be required (as described below) to write the primitive to the primitive lists corresponding to those regions.

The data that is stored for the primitive to indicate the set of regions covered by the primitive could comprise data indicating (e.g. the full positions of) of each of the regions that it covers (i.e. at least partially falls within).

However, in some embodiments of the technology described herein, when adding the primitive to the group (and writing it to storage), rather than store full “raw” data indicating the set of regions covered by the primitive, more minimal data that indicates the set of regions covered by the primitive is stored. This minimal data is in an embodiment such that it can, when used in conjunction with other data (e.g. data indicating the set of regions covered by the earliest primitive in the group, that is stored when the group is “defined” by that earliest primitive, as discussed further below), indicate the set of set of regions covered by the primitive.

For example, in embodiments (discussed above) wherein a primitive is only grouped with one or more previous primitives when a determined bounding box for the primitive is within an offset threshold from a determined bounding box for a previous (e.g. earliest) primitive, data indicating the offset of the bounding box of the primitive (relative to the bounding box of the previous (e.g. earliest) primitive) is stored (rather than full “raw” data indicating the position of regions covered by the primitive in the render output), since this will be sufficient in order to later write the primitive to primitive lists (when used in conjunction with data indicating the set of regions covered by (the bounding box of) the previous (e.g. earlier) primitive, which, as discussed below, is in an embodiment stored when the group “defined” by that earliest primitive).

Similarly, in embodiments (discussed above) wherein a primitive is only grouped with one or more previous primitives when the respective sets of regions covered by the primitive and a previous primitive are within a particular same “superset” of regions, data indicating the positions of the regions that are covered by the primitive are stored (e.g. using a bitmask) (rather than full “raw” data indicating the position of regions covered by the primitive in the render output as a whole), since this will be sufficient in order to later write the primitive to primitive lists.

In other embodiments (discussed above) wherein a primitive can only be grouped with one or more previous primitives when the primitive covers (i.e. at least partially falls within) a set of regions of render output that exactly matches the set of regions covered by a previous primitive, it is not necessary to store any data indicating the set of regions covered by the specific primitive (since, as will be understood, that set of regions will necessarily be the same as another primitive in the group for the “match” of sets of regions to have occurred, and thus should already be known from (and e.g. stored for the group) e.g., when the group is “defined” by an earlier primitive (as will be discussed further below)).

The primitive is in an embodiment written to the storage (when being added to the group of primitives) along with any data associated with the primitive that will later be written (along with the primitive) to primitive list(s). For example, in some embodiments, the primitive is written to storage along with a (e.g. 4-bit) coverage mask which indicates which portions of a region of the render output the primitive appears in.

In embodiments, once the primitive has been added to the group with the one or more previous primitives (and stored (along with any necessary data) alongside those one or more previous primitives), further (subsequent) primitives can be processed. Thus, once the primitive has been added to the group with the one or more previous primitives, it will in an embodiment then be determined whether a future (subsequent) primitive can be grouped with one or more previous primitives (including the primitive that has just been added to the group), in a corresponding manner to the methods described above. More (subsequent) primitives may be added to the group as they are processed, in this manner, thereby building up the group.

Thus, in embodiments, once the primitive is grouped with one or more previous primitives, it is determined whether a further (subsequent) primitive can be grouped with the one or more previous primitives (including the now-grouped primitive) for the purpose of being written to one or more primitive lists, and when it is determined that the further (subsequent) primitive can be grouped with the one or more previous primitives, the further (subsequent) primitive is grouped with the one or more previous primitives (including the newly-grouped primitive), etc.

The number of primitives that are grouped together in the manner of the technology described herein may therefore build up over time, as more and more primitives are determined to be able to be added (and subsequently are added) to the group.

When it is determined that a primitive cannot be grouped with any previous primitives (because, e.g., and as discussed above, the set of regions covered by the primitive and/or other feature(s) of the primitive has been determined to not be the same as (or sufficiently similar to) one or more previous primitives) then the primitive is in an embodiment not grouped with one or more previous primitives.

The Applicants have recognised that, in the case wherein it is determined that a primitive cannot be grouped with one or more previous primitives, if that primitive were then be written to its required primitive lists before the one or more “grouped” primitives have been written to their required primitive lists (and if it so happens that the primitive and a previous primitive need to be written to a same primitive list), this could result in the primitives being written to primitive lists “out of order” (i.e. with the later primitive being written to a primitive list before an earlier “grouped” primitive is written to that same primitive list). As will be understood, writing primitives to lists out of order can lead to additional complications in the tiling process, and/or when the primitive lists are used later in the rendering pipeline.

Thus, to ensure that the primitives are written to primitive lists in the correct order, it is in an embodiment the case that once it is determined that a primitive cannot be grouped (i.e. added to a group with) previous primitives, this triggers the writing of those previous primitives from the group to their respective primitive lists.

Thus, in particularly embodiments, the method further comprises (and the system is correspondingly configured to) when it is determined that a primitive cannot be grouped with one or more previous primitives, triggering writing one or more previous primitives together to one or more primitive lists, without grouping the primitive with one or more previous primitives.

The writing of one or more previous (grouped) primitives to primitive lists could also, or instead, be triggered by other means.

For example, in some embodiments, the group of primitives could have a maximum allowed size (i.e. a maximum number of primitives that are allowed to be in the group). In these embodiments, it could be (and in an embodiment is) the case that grouped primitives are written out to primitive lists once the group has reached its maximum size (since at that point, no more primitives should be added to the group).

Thus, according to another embodiment of the technology described herein, the step of writing grouped primitives together to one or more primitive lists is triggered by the number of grouped primitives reaching a threshold.

The threshold (i.e. the maximum number of primitives that are allowed in the group) can be chosen as desired. For example, the threshold could be chosen based on the size of the storage that is available to store the group of primitives. In one embodiment, the threshold number of primitives is 4. In another embodiment, the threshold number of primitives is 8. (Other arrangements are of course possible, however.)

After triggering the writing of one or more (grouped) previous primitives to their primitive lists, it is in an embodiment possible for a new group of primitives to be started (and, e.g., built up, by adding further primitives to the group, e.g. in the manner described above).

In some embodiments, a new group of primitives can only be started once all of the previous (grouped) primitives have been written to their primitive lists. Thus, in these embodiments, all of the grouped primitives are written to their primitive lists (such that the group can then be considered “empty”), before a new group of primitives is started. In other words, the starting of a new group of primitives is stalled until all of the previous grouped primitives are written to their primitive lists.

In other embodiments, rather than necessarily waiting for all of the previous (grouped) primitives to be written to their primitive lists before starting a new group of primitives, the new group of primitives can be started before all of the previous grouped primitives have been written to their primitive lists. In other words, the starting (and, in some embodiments, the building up of) the new group of primitives overlaps (temporally) with the writing of the previous (grouped) primitives to their primitive lists.

Allowing the process of starting (and e.g. building up) a new group to begin before the process of writing out the previous (grouped) primitives has completed is advantageous, since overlapping those two processes may reduce the overall time required to process the sequence of primitives. However, and as will be understood, in these embodiments, since the new group of primitives and the previous group (of previously grouped primitives) may exist concurrently, the system will need to be capable of storing (at least some of) the new group and (at least some of) the previous group, at the same time.

In embodiments, when starting a new group of primitives, the new group of primitives is started by (and “defined” by) the next primitive to be processed. For example, in the embodiment described above, wherein determining that a primitive cannot be grouped with one or more previous primitives triggers writing the grouped primitives together to one or more primitive lists, the new group may be started by that primitive that was determined to be not be able to be grouped with the one or more previous primitives.

The primitive that starts a group (to which subsequent primitives can be added, in the manner of the technology described herein described above) can be considered to be the “earliest” primitive in the group, going forward. Thus, in embodiments of the technology described herein (discussed above) it is this “earliest” primitive in the group that defines the group going forward (and that, for example, subsequent primitives are compared to when determining whether or not to add those primitives to the group).

The primitive that starts a group is in an embodiment written to storage when starting the new group, e.g. in the same manner described above in relation to the adding of a primitive to an (already-established) group.

In embodiments, when this earliest primitive of the group is written to storage, it is stored in association with data indicating the set of regions covered by this earliest primitive of the new group. This data indicating the set of regions covered by this earliest primitive of the group can (and should) be used when comparing subsequent primitives with that earliest primitive to determine whether a subsequent primitive can be grouped with (i.e. added to the group with) that earliest primitive (in the manner described above), and can also be used when writing primitives from the group to their primitive lists.

In the technology described herein, primitives that have been grouped together (in the manner described above) are written together to one or more primitive lists. This means that, in the process of writing grouped primitives to primitive lists, it should be the case that multiple (i.e. two, and in an embodiment more) of the grouped primitives are written to a primitive list in a single primitive list write cycle.

As will be understood, this means that the write bandwidth should be, and in an embodiment is, large enough to support the writing of multiple (i.e. two, and in an embodiment more) primitives to a particular primitive list during a single primitive list write cycle. In embodiments, the write bandwidth is large enough to support the writing of a number of primitives to a particular list during a single write cycle equal to the maximum number of primitives that can be in the group of primitives (i.e. the threshold number of primitives in the group, as discussed above).

The writing of primitives grouped primitives together to primitive lists can be carried out in any suitable and desired manner. In an embodiment, it is done by considering each of the regions covered by any of the grouped primitives in turn, and for each of those regions, writing all of the primitives in the group that cover that region together to the primitive list corresponding to that region (in a single primitive list write cycle).

Thus, in embodiments, the step of writing grouped primitives together to one or more primitive lists comprises: for each of the one or more regions covered by the grouped primitives, writing to the primitive list corresponding to that region all of the grouped primitives that cover that region in a single primitive list write cycle.

As will be understood, in order for the grouped primitives to be written to the correct primitive lists, the system will necessarily need to know what regions of the render output are covered by each of the primitives that is being written from the group to the primitive lists (or, correspondingly, which of the grouped primitives fall within each region). In an embodiment, this is determined using the data stored for each of the primitives indicating the regions that the primitive covers (i.e. at least partially falls within), and/or the data stored for the earliest primitive in the group (i.e. that is used to define the group) that indicates the set of regions covered by the earliest primitive.

For example, in embodiments (discussed above) wherein primitives are only grouped together when they are determined to cover exactly the same set of regions of the render output as one another, the data indicating the set of regions covered by the earliest primitive of the group will sufficiently indicate the set of regions that each of the grouped primitives covers.

In embodiments (discussed above) wherein a primitive is only grouped with one or more previous primitives when a determined bounding box for the primitive is within an offset threshold from a determined bounding box for a previous (e.g. the earliest) primitive in the group, then the set of regions covered by a particular primitive can be determined using the data indicating the offset of the bounding box of the primitive (relative to the bounding box of earliest primitive) along with the data indicating the set of regions covered by the previous (e.g. earliest) primitive of the group.

In embodiments (discussed above) wherein a primitive is only grouped with one or more previous primitives when the respective sets of regions covered by the primitive and a previous (e.g. earliest) primitive in the group are within a particular same “superset” of regions, then the set of regions covered by a particular primitive can be determined using data (e.g. a bitmask) indicating the positions of the regions in the superset that are covered by the primitive (along with, e.g., data indicating the “superset” of regions, if necessary).

Once all primitives in the group of primitives have been written to their required primitive lists, then the group may be considered “empty”, and a new group can be started by a subsequent primitive to be processed (as described above).

The technology described herein may generally find application in any suitable tile-based rendering graphics processing system.

The technology described herein can be used for all forms of output that a graphics processing pipeline may be used to generate, such as frames for display, render to texture outputs, etc.

In some embodiments, the graphics processing system comprises, and/or is in communication with, one or more memories and/or memory devices that store the data described herein, and/or store software for performing the processes described herein. The graphics processing system may also be in communication with a host microprocessor, and/or with a display for displaying images based on the data generated by the graphics processing system.

In an embodiment, the various functions of the technology described herein are carried out on a single graphics processing platform that generates and outputs the rendered fragment data that is, e.g., written to a frame buffer for a display device.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, and pipelines of the technology described herein may comprise a suitable processor or processors, controller or controllers, functional units, circuits/circuitry, processing logic, microprocessor arrangements, etc., that are operable to perform the various functions, etc., such as appropriately configured dedicated hardware elements or processing circuits/circuitry, and/or programmable hardware elements or processing circuits/circuitry that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits/circuitry, if desired.

Thus the technology described herein extends to a graphics processor and to a graphics processing platform including the apparatus of or operated in accordance with any one or more of the embodiments of the technology described herein described herein. Subject to any hardware necessary to carry out the specific functions discussed above, such a graphics processor can otherwise include any one or more or all of the usual functional units, etc., that graphics processors include.

It will also be appreciated by those skilled in the art that all of the described embodiments and embodiments of the technology described herein can, and in an embodiment do, include, as appropriate, any one or more or all of the features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code configured to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a graphics processor, renderer or microprocessor system comprising a data processor causes in conjunction with said data processor said processor, renderer or system to carry out the steps of the methods of the technology described herein. Such a computer software carrier could be a physical storage medium such as a ROM chip, RAM, flash memory, CD ROM or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible medium, such as a non transitory computer readable medium, for example, diskette, CD ROM, ROM, RAM, flash memory or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre loaded with a computer system, for example, on a system ROM or fixed disk, or distributed from a server or electronic bulletin board over a network, for example, the Internet or World Wide Web.

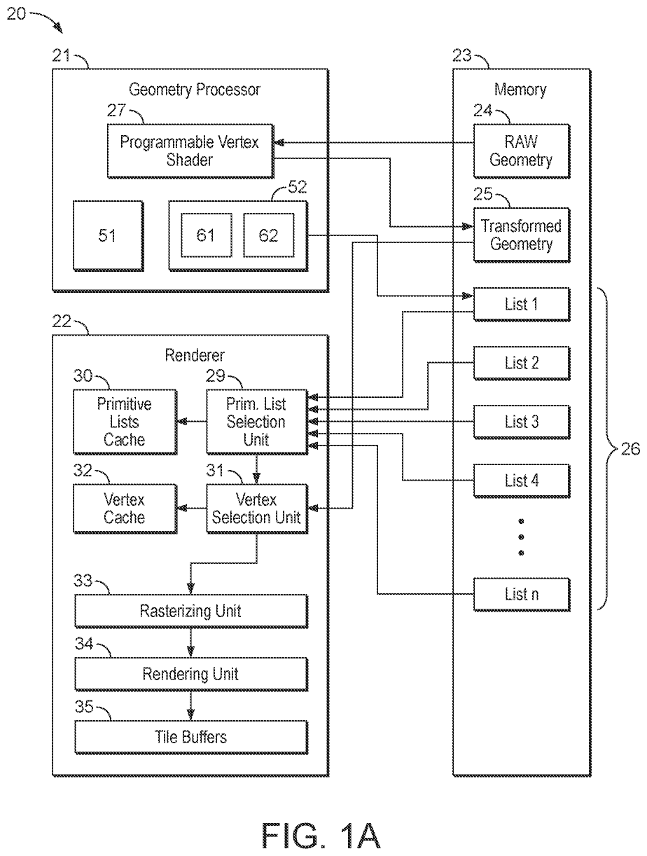

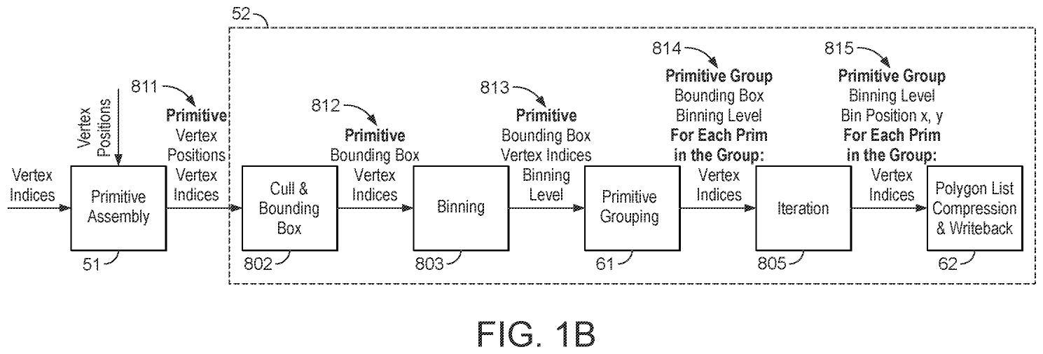

FIG. 1A shows schematically a graphics processor 20 that may be operated in accordance with the technology described herein. The graphics processor 20 includes a geometry processor 21, and a renderer 22, both of which can access a memory 23. The memory 23 may be “on chip” with the geometry processor 21 and renderer 22, or may be an external memory that can be accessed by the geometry processor 21 and renderer 22.

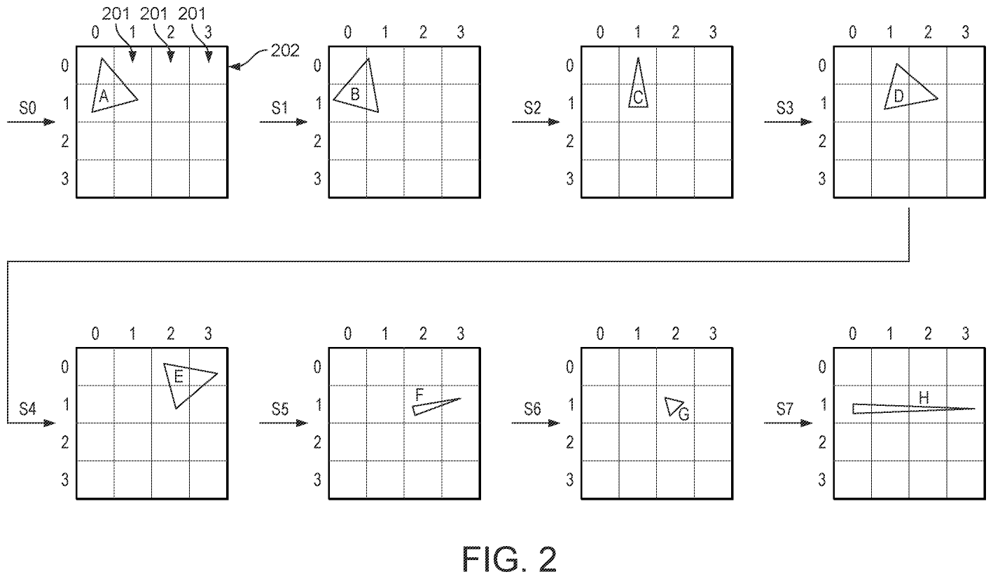

The memory 23 stores, inter alia, and as shown in FIG. 2, a set of raw geometry data 24 (which is, for example, provided by the graphics processor driver or an API running on a host system (microprocessor) of the graphics processor 20), a set of transformed geometry data 25 (which is the result of various transformation and processing operations carried out on the raw geometry 24) and a set of primitive lists 26.

Each primitive list 26 corresponds to a particular region (tile) of the render output being generated, and contains a list of primitives to be rendered for that region (tile).

The transformed geometry data 25 comprises, for example, transformed vertices (vertex data), etc.

The geometry processor 21 comprises, inter alia, a programmable vertex shader 27, a primitive assembly stage 51, and a tiling unit 52 comprising a primitive grouping unit 61 and a primitive list writing circuit 62.

The programmable vertex shader 27 takes as it input the raw geometry data 24 stored in the memory 23, and processes that data to provide transformed geometry data 25 (which it then stores in the memory 23) comprising the geometry data in a form that is ready for two-dimensional (‘2D’) placement in the frame to be displayed. The programmable vertex shader 27 and the processes it carries out can take any suitable form and be any suitable and desired such processes. The primitive assembly stage 51 takes as its input the transformed and processed vertex data from the programmable vertex shader 27, and assembles geometric primitives using that data.

The tiling unit 52 carries out the tiling, primitive grouping and primitive list writing processes of the technology described herein, in order to prepare the primitive lists which are subsequently used by the renderer 22. To do this, the tiling unit 52 takes as its input the assembled primitives from the primitive assembly stage 51. The tiling unit 52 determines the regions (tiles) of the render output that a primitive falls within (e.g. using a bounding box technique), and the primitive grouping unit 61 then determines whether or not the primitive can be grouped with other (previous) primitives. If it can, the primitive grouping unit 61 adds the primitive to the group of primitives, in the present embodiment by storing the primitive along with any associated data locally as pipeline data. The primitive list writing circuit 62 writes primitives from the group of primitives stored locally to the pipeline to primitive lists 26 which are stored in memory 23.

Although, in the present embodiment, the group of primitives is stored locally to the processing pipeline as they are being built up (i.e. whilst primitives are being added to the group of primitives), it would of course be possible to instead store the group of primitives in (main) memory as they are being built up.

In the present embodiment, when the primitive list writing circuit 62 is triggered to write “grouped” primitives from the group of primitives to one or more primitive lists 26, the primitives are written directly from storage local to the pipeline (where the group of primitives are built up) to primitive lists 26. However, it would be possible to instead write the group of primitives from the storage local to the pipeline to one or more additional storage elements (such as one or more additional registers or FIFOs), with the primitives in the group of primitives then being written by the primitive list writing circuit 26 from the additional one or more storage elements to the primitive lists 26.

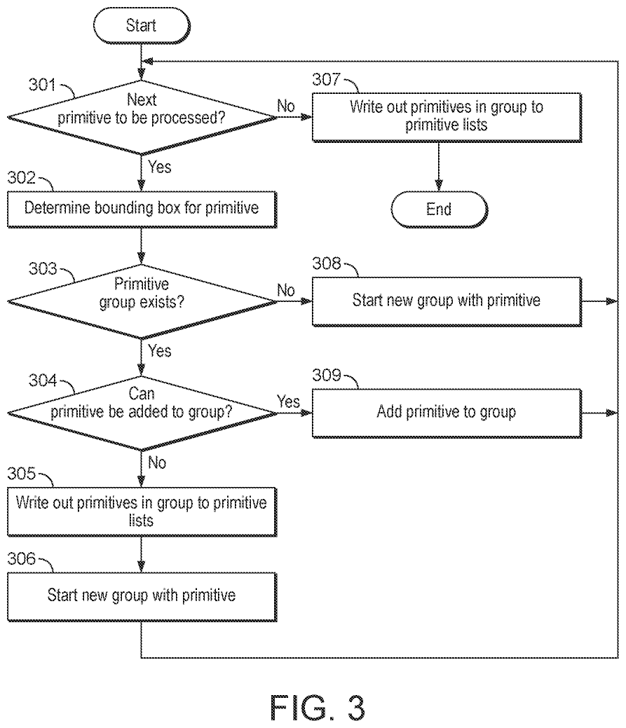

The processes of grouping primitives and writing grouped primitives to primitive lists will be discussed further below with reference to FIGS. 3-6.

The renderer 22 includes a primitive list selection unit 29, a primitive list cache 30, a vertex selection unit 31, a vertex data cache 32, a rasterising unit 33, a rendering unit 34, and tile buffers 35. The renderer operates on a tile-by-tile basis.

The rasterising unit 33, rendering unit 34, tile buffers 35 operate, in this embodiment, in the same manner as such units normally operate in graphics processing systems. Thus the rasterising unit 33 takes as its input a primitive and its vertices, rasterises the primitive to fragments, and provides those fragments to the rendering unit 34. The rendering unit 34 then performs a number of rendering processes, such as texture mapping, blending, shading, etc. on the fragments, and generates rendered fragment data which it stores in the tile buffers 35 for providing to a frame buffer for display.

The primitive list selection unit 29 of the renderer 22 determines which primitive is to be rendered next. It does this by considering the primitive list 26 stored in the memory 23 for the tile being rendered, and selecting that list the next primitive to be rendered.

The primitive list selection unit 29 can also place one or more primitive lists in the primitive list cache 30.

The primitive list selection unit 29 provides the primitive that it has selected for rendering next to the vertex selection unit 31. In response to this, the vertex selection unit 31 retrieves the appropriate transformed vertex data for the primitive in question from the transformed geometry data 25 stored in the memory 23, and then provides the primitive (i.e. its transformed vertex data) to the rasterising unit 33 for processing. The vertex selection unit 31 can cache vertex data that it has retrieved from the memory 23 in the vertex data cache 32, if desired.

FIG. 1B shows the primitive assembly stage 51 and tiling unit 52 (including the primitive grouping unit 61 and primitive list writing circuit 62) and their operation in further detail.

As discussed above, the primitive assembly stage 51 takes as its input transformed and processed vertex data (from programmable vertex shader 27), assembles geometric primitives using that data, and outputs a sequence of assembled primitives 811 to the tiling stage (tiling unit) 52. The sequence of assembled primitives 811 includes a set of vertex positions and vertex indices for each primitive. As shown in FIG. 1B, the tiling process first comprises a culling and bounding box generator stage 802, which is then followed by a binning stage 803, primitive grouping unit (stage) 61, iteration stage 805 and primitive list writing circuit (stage) 62.

The culling and bounding box generator 802 generates appropriate bounding boxes for the assembled primitives output by the primitive assembly stage 51, and also operates to identify any primitives that can be culled from further processing on the basis of their potential visibility. (In the present embodiment this visibility culling uses one or more of front/back-face culling, frustum culling, and sample aware culling but other arrangements would, of course, be possible.)

The bounding box generation uses the provided positions for the assembled primitives to generate appropriate bounding boxes for the primitives. In the present embodiment, the bounding boxes are derived at the resolution of (i.e. are rounded to the size of) the regions (e.g. rendering tiles) that the render output is divided into and that the primitive lists are prepared for (but other arrangements would, of course, be possible). The output 812 from the culling and bounding box generation comprises for each primitive a set of vertex indices for the primitive and bounding box data for the primitive.

The binning stage 803 takes the bounding box for a primitive and determines a “binning level” for the primitive, i.e. the level in the hierarchy of sets of regions (for which primitive lists can be prepared) at which the primitive should be written to one or more primitive lists. For example, the primitive could be written to one or more primitive lists corresponding to regions at a lowest (i.e. binning level=0) layer of the hierarchy, wherein the regions correspond to individual tiles of the render output. Alternatively, the primitive could be written to one or more primitive lists corresponding to regions at a higher layer of the hierarchy (e.g. at a binning level=1, wherein each region corresponds to a 2×2 tiles of the render output).

The binning level may be chosen based on any suitable or desired criteria. For example, the binning level may be chosen to achieve a suitable and desired balance between the processing costs associated with writing primitives to and reading primitives from primitive lists (since, and as will be understood, binning a primitive at a higher layer of the hierarchy may the reduce the total number of primitive lists that the primitive will need to be written to, whilst also potentially increasing the number of times that a primitive will need to be read from primitive lists when rendering individual tiles of the render output).

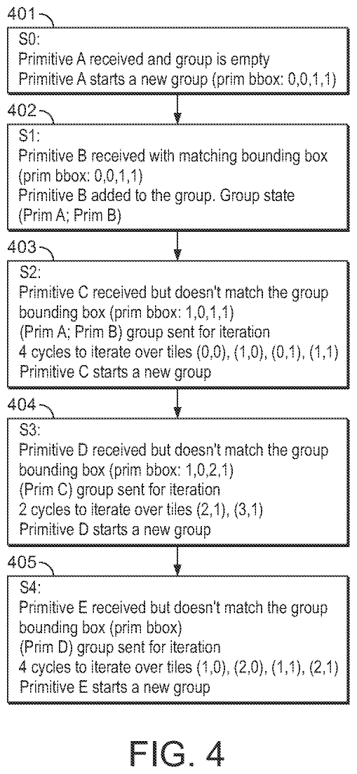

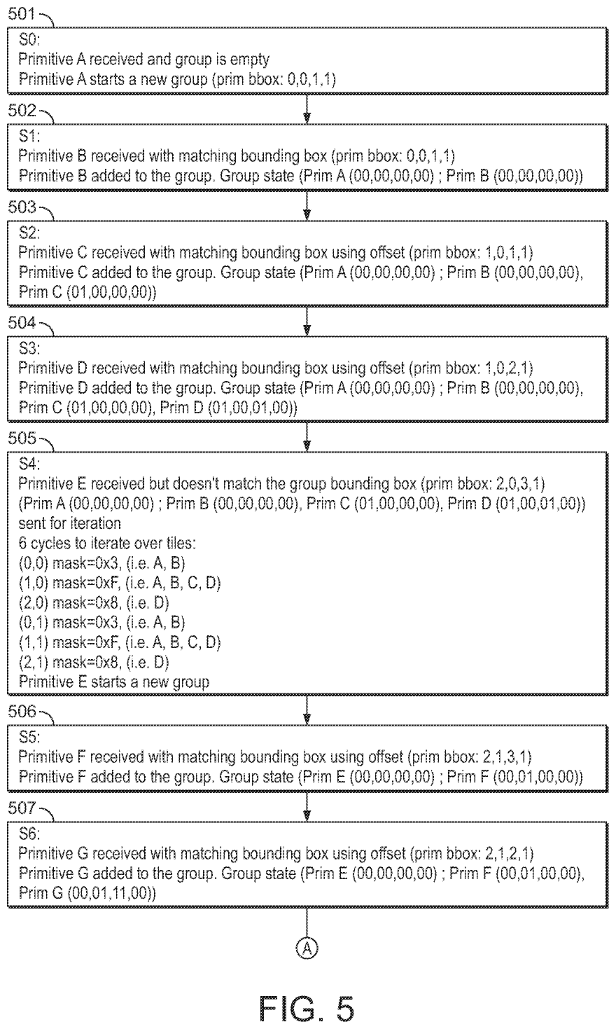

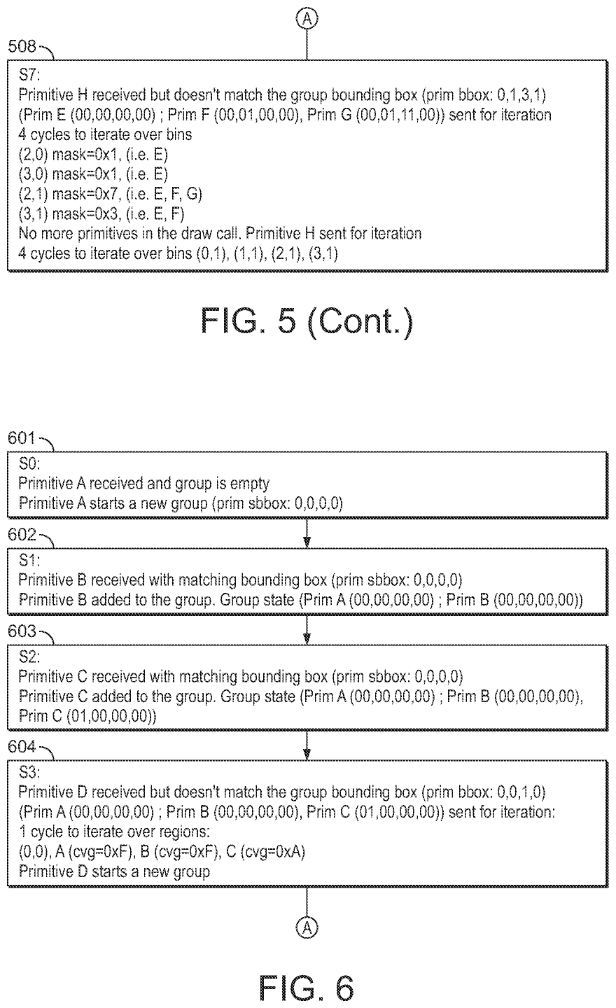

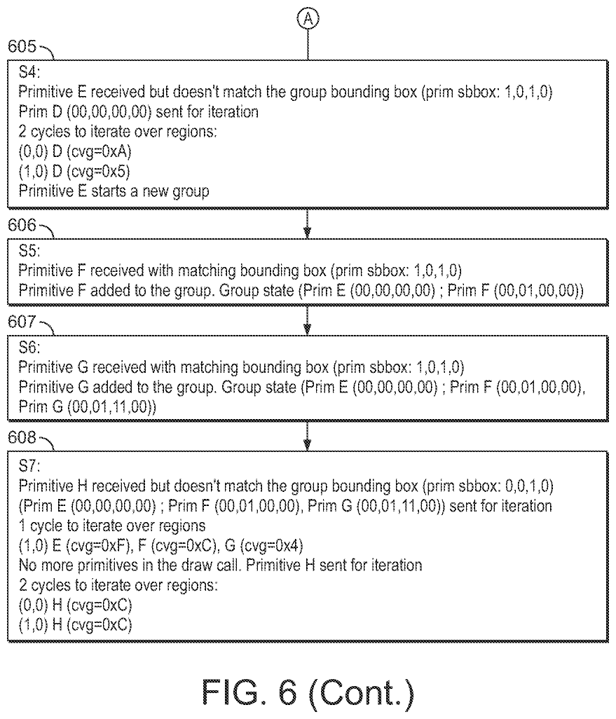

(As discussed further below, FIGS. 4 and 5 relate to embodiments wherein primitives are added to primitive lists for regions corresponding to individual tiles of the render output (i.e. at a binning level=0), whereas FIG. 6 relates to an embodiment wherein primitives are added to primitive lists corresponding to regions that each cover 2×2 tiles of the render output (i.e. at a binning level=1)).

The binning level and bounding box data for the primitive (output 813 by the binning stage 803) indicates the set of regions that the primitive covers (i.e. at least falls within), and the primitive grouping unit 61 uses this to identify whether or not the primitive can be “grouped” (i.e. added to a group) with one or more previous primitives. The group of primitives builds up over time as the primitive grouping unit 61 adds more primitives to the group, until it is triggered to write the grouped primitives to their required primitive lists. (The processes of adding primitives to primitive groups and triggering of writing grouped primitives to primitive lists is discussed in further detail below with reference to FIGS. 3-6).

When primitives in the group of primitives are triggered to be written to their required primitive lists, the primitive grouping unit 61 outputs 814 the group of primitives, including bounding box (and binning level) data that identifies the group of primitives, and data for each of the primitives in the group (including, e.g., data indicating the set of regions covered by each primitive, such as bounding box offset data for each primitive, as discussed below in relation to the embodiment of FIG. 5).

The iterator 805 takes the group of primitives and outputs 815 the set of primitive lists (bins) that grouped primitives should be written to. The primitive lists (bins) are identified by (x, y) positions of the regions (e.g. tiles) to which they correspond. In some embodiments (e.g. as discussed in relation to FIG. 5 below) a primitive bitmask is generated for each primitive list to indicate which of the grouped primitives should be written to that primitive list. The primitive list writing circuit 62 then writes the grouped primitives into the respective primitive lists 26 in memory 23.

FIG. 2 illustrates a sequence of primitives to be processed. The sequence of primitives (draw call) includes eight primitives A-H that are to be processed one after another.

FIG. 2 shows the position of each primitive within the render output 201, which is divided into tiles 202. Different primitives may fall within (i.e. cover) different tiles 202 of the render output 201, and a single primitive may fall within multiple tiles. For example, primitive A falls within four tiles (i.e. tiles (0,0); (1,0); (0,1) and (1,1)), whereas primitive G only falls within one tile (i.e. tile (2,1)).

In a tile-based graphics processing system, tiles are processed individually in order to generate the render output 202. Therefore primitive A (for example) will have to be processed for each individual tile it falls within, and hence should be written to each of the four separate primitive lists that correspond to each of those four tiles.

FIG. 3 shows a flow chart for grouping and writing (grouped) primitives to primitive lists according to an embodiment of the technology described herein. The operation of FIG. 3 is carried out by the tiling unit 52.

As discussed above, the tiling unit 52 receives as its input a sequence of assembled primitives from primitive assembly stage 51. When there is a (next) primitive in the sequence to be processed (step 301), the tiling unit determines a “bounding box” for the primitive (step 302), in order to determine which regions (in the present embodiment corresponding to render tiles) of the render output the primitive in question falls within.

The primitive grouping unit of the tiling unit then determines whether there is a group of (one or more) previous primitives (in the sequence of primitives) available for (potential) grouping with the primitive being processed (step 303).

When no such group of one or more previous primitives exists, the primitive grouping unit starts a new group using the primitive being processed (step 308). This primitive is then considered the “earliest” primitive in the group going forwards. The primitive that starts (and thus “defines”) the new group is stored in association with data indicating the set of regions covered by (the bounding box of) the primitive (which, as discussed below, will later be used to determine whether subsequent primitives can be added to the group with the primitive). The tiling unit will then return to step 301 (to process a next primitive, if one is available).

When a group of one or more previous primitives does already exist, then the primitive grouping unit determines whether or not the primitive being processed can be added to the group (i.e. “grouped”) with those one or previous primitives (step 304). This is done by comparing the set of regions covered by (the bounding box of) the primitive being processed relative to the set of regions (tiles) covered by (the bounding box of) the earliest primitive in the group (i.e. the primitive that started and “defined” the group in step 308 or 306) using the data indicating the set of regions (tiles) covered by (the bounding box of) that earliest primitive in the group that was stored in memory (in step 308 or 306).

The criteria that the primitive grouping unit uses to determine whether or not the primitive can be added to the group with one or more previous primitives is discussed further below, with reference to FIGS. 4-6.

When it is determined that the primitive can be grouped with the one or more previous primitives, the primitive is grouped (i.e. added to the group) with the one or more primitives (step 309). This is done by the primitive grouping unit storing the primitive alongside the other (one or more previous) primitives in the group. The primitive is stored in association with data indicating the set of regions (tiles) covered by the primitive (that will later be used to write the primitive to primitive list(s)), if required. The tiling unit will then return to step 301 (to process a next primitive, if one is available).

However, when it is determined that the primitive cannot be grouped with the group of one or more previous primitives, then the primitive is not grouped with the one or more primitives, and this instead triggers the primitive list writing circuit to write primitives in the group (i.e. grouped primitives) to primitive lists (step 305).

To write the primitives in the group to primitive lists, the primitive list writing circuit iterates over each of the regions (tiles) covered by the grouped primitives, and for each of those regions (tiles), writes all the grouped primitives that cover that region (tile) to the primitive list corresponding to that region (tile) in a single primitive list write cycle. This means that when there are multiple grouped primitives that cover a same region (tile) of the render output, they will be written together to the primitive list corresponding to that region (tile), in a single primitive list write cycle. In order to write each primitive to the correct set of primitive lists, the primitive list writing unit uses the data indicating the set of regions (tiles) covered by the primitive (e.g. that is stored for the primitive in step 306, 308 or 309, if present).

Once the grouped primitives have all been written to their required primitive lists, then the group is considered “empty”, and the primitive grouping unit starts a new group using the primitive being processed (i.e. the primitive that was not grouped with the previous one or more primitives) (step 306). Similarly to step 308, the primitive that starts the new group (and can be considered to “define” the group going forwards) is stored in association with data indicating the set of regions (tiles) covered by (the bounding box of) the primitive.

The tiling unit will then return to step 301 (to process a next primitive, if one is available).

When there are no more primitives to be processed in the sequence of primitives (step 301), the primitive list writing unit writes out any primitives that are left in the group to their required primitive lists (step 307). This is carried out in a similar manner to step 305, as described above.

FIGS. 4-6 show processes for grouping primitives of the sequence of primitives shown in FIG. 2, and writing those primitives to primitive lists according to various different embodiments of the technology described herein.

In each of these embodiments, for a primitive that is being processed, the set of regions covered by the primitive is determined using a “bounding box” technique (see step 303 in FIG. 3). As described above, this includes drawing a box around the primitive, and determining the set of regions covered by the bounding box. Each bounding box is defined by its attributes (xmin, ymin, xmax, ymax)

In the embodiments of FIGS. 4 and 5, the bounding box is rounded to the size of the regions (tiles) 202 that the render output 201 is divided into. Thus, for example, the bounding box of primitive A has attributes of (0, 0, 1, 1), whereas the bounding box of primitive G has corresponding attributes of (2, 1, 2, 1).

FIG. 4 illustrates an embodiment of the technology described herein wherein it is (only) determined that a primitive can be added to a group (i.e. “grouped”) with previous primitives when the set of regions covered by (the bounding box of) the primitive exactly matches the set of regions covered by (the bounding box of) the previous primitives in the group.

In S0 (401), primitive A is processed by the tiling unit. The primitive grouping unit determines that there is no group available for grouping (i.e. the group is “empty”) and so primitive A starts a new group based on its bounding box with attributes (0, 0, 1, 1). Data indicating the bounding box for the primitive A (that defines the group going forward) is stored, which is used when determining whether subsequent primitives can be added to the group.

In S1 (402), primitive B is processed. The primitive grouping unit determines that the bounding box for primitive B exactly matches that of primitive A and so it is determined that primitive B can be added to the group with primitive A. Primitive B is therefore added to the group with primitive A.

In S2 (403), primitive C is processed. The bounding box for primitive C with attributes (1, 0, 1, 1) does not match the bounding box of primitive A, and so the primitive grouping unit determines that primitive C cannot be added to the group with primitives A and B.

This triggers the writing of the primitives in the group (i.e. primitives A and B) to their required primitive lists. The primitive list writing circuit uses the data indicating the bounding box for primitive A (stored in step S0 (401)) to determine which primitive lists (corresponding to which tiles of the render output) the primitives should be written to. As will be understood, because primitives A and B both cover the (exact) same set of tiles of the render output, they will both need to be written to the same primitive lists corresponding to those tiles (i.e. the primitive lists corresponding to tiles (0,0), (1,0), (0,1) and (1,1)).

The primitive list writing circuit iterates over all of those tiles (0,0), (1,0), (0,1) and (1,1) that the grouped primitives A and B cover, and for each of those tiles, writes both of the grouped primitives together to the primitive list corresponding to that tile in a single primitive list write cycle. Thus the primitive list writing circuit writes primitives A and B together to the primitive list corresponding to tile (0,0) in a first primitive list write cycle, and then writes primitives A and B together to the primitive list corresponding to tile (1,0) in a second primitive list write cycle, etc. and so on. It takes four primitive list write cycles in total to write primitives A and B together to the primitive lists corresponding to the four tiles (i.e. one primitive list write cycle for each tile).

Once primitives A and B in the group have been written to their required primitive lists in this manner, the group can be considered “empty”, and a new group is started by primitive C based on its bounding box attributes (1, 0, 1, 1). Data indicating the bounding box for the primitive C (that defines this new group going forward) is stored.

In S3 (404) primitive D is processed. The bounding box for primitive D with attributes (1, 0, 2, 1) does not match the bounding box of primitive C, and so the primitive grouping unit determines that primitive D cannot be added to the group with primitive C.

This triggers the writing of the primitive C (i.e. the only primitive in the group) to its required primitive lists (i.e. the primitive lists corresponding to the tiles covered by primitive C, i.e. tiles (1,0) and (1,1)). It takes one primitive list write cycle to write primitive C to the primitive list corresponding to tile (1,0) and one primitive list write cycle to write primitive C to the primitive list corresponding to tile (1,1) (i.e. it takes two primitive list write cycles in total to write primitive C to the two primitive lists).

Once primitive C (i.e. the only primitive in the group) has been written to its required primitive lists, the group can be considered “empty” once again, and a new group is started by primitive D based on its bounding box attributes (1, 0, 2, 1). Data indicating the bounding box for the primitive D (that defines this new group going forward) is stored.

In S4 (405) primitive E is processed. The bounding box for primitive E with attributes (2, 0, 3, 1) does not (exactly) match the bounding box of primitive D, and so the primitive grouping unit determines that primitive D cannot be added to the group with primitive C. This triggers the writing of primitive D (i.e. the only primitive in the group) to its primitive lists, and once this is done, a new group is started by primitive E based on its attributes.

The tiling unit will then go on to process remaining primitives F-H (not shown).

FIG. 5 illustrates another embodiment of the technology described herein, wherein it is (only) determined that a primitive can be added to a group (i.e. “grouped”) with previous primitives when the bounding box for the primitive is offset from the bounding box of the earliest primitive in the group (i.e. the primitive that starts and can be considered to have “defined” the group) within an offset threshold of 1 unit tile length.

Thus, in this embodiment, the bounding boxes for the primitive being processed and the earliest primitive in the group do not have to exactly match for it to be determined that the primitive can be added to the group, but the attributes of (xmin, ymin, xmax, ymax) of the bounding box for the primitive should all be no more than 1 unit away from (i.e. above or below) the corresponding attributes of bounding box of the earliest primitive in the group.

As described further below, offset data for a primitive is stored when a primitive joins the group, which encodes each of the offsets for each of the attributes (xmin, ymin, xmax, ymax) of the primitive's bounding box, relative to the bounding box of the earliest primitive in the group. The encoding of each possible offset for each of the attributes is as below:
00—no offset
01—offset +1
11—offset −1

In S0 (501), primitive A is processed by the tiling unit. The primitive grouping unit determines that there is no group available for grouping (i.e. the group is “empty”) and so primitive A starts a new group based on its bounding box with attributes (0, 0, 1, 1). Data indicating the bounding box for the primitive A (that defines the group going forward) is stored, which is used when determining whether subsequent primitives can be added to the group.

In S1 (502), primitive B is processed. The primitive grouping unit determines that the bounding box for primitive B exactly matches that of primitive A (i.e. it is within the allowed offset), and so it is determined that primitive B can be added to the group with primitive A. Primitive B is therefore added to the group with primitive A, and offset data (00, 00, 00, 00) is stored for primitive B (to indicate that the xmin, ymin, xmax, ymax of primitive B's bounding box are the same as that of primitive A).

In S2 (503), primitive C is processed. The bounding box for primitive C with attributes (1, 0, 1, 1) is within the allowed offset from the bounding box of primitive A, and so the primitive grouping unit determines that primitive C can be added to the group with primitives A and B. Primitive C is therefore added to the group with primitives A and B. Offset data (01, 00, 00, 00) is stored for primitive C (to indicate that xmin of primitive C's bounding box is +1 compared to xmin of primitive A's bounding box, but ymin, xmax and ymax of the respective bounding boxes are the same).

In S3 (504), primitive D is processed. The bounding box for primitive D with attributes (1, 0, 2, 1) is within the allowed offset from the bounding box of primitive A, and so the primitive grouping unit determines that primitive D can be added to the group with primitives A, B and C. Primitive D is therefore added to the group with primitives A, B and C. Offset data (01, 00, 01, 00) is stored for primitive D (to indicate that xmin and xmax of primitive C's bounding box are +1 compared to xmin and xmax of primitive A's bounding box, but the ymin, and ymax attributes of the respective bounding boxes are the same).

In S4 (505), primitive E is processed. The bounding box for primitive E with attributes (2, 0, 3, 1) is not within the allowed offset from the bounding box of primitive A, and so the primitive grouping unit determines that primitive E cannot be added to the group with primitives A, B, C and D.

This triggers the writing of the primitives in the group (i.e. primitives A, B, C and D) to their required primitive lists. To write primitives to a primitive list (corresponding to a particular tile of the render output), a mask for the tile is generated which indicates which primitives in the group need to be written out to the primitive list for that tile, using the offset data stored for each primitive in the group.

For example, for the tile (0, 0), a mask of 0x3 is generated, which indicates that primitives A and B (only) need to be written to the primitive list corresponding to tile (0, 0). The primitive list writing circuit then uses this mask to write both primitive A and primitive B (but not primitives C or D) together to the primitive list corresponding to tile (0, 0) in a single primitive list write cycle.

This process is repeated for each of the primitive lists corresponding to each of the tiles that are covered by primitives in the group.

Thus, after writing primitives A and B to the primitive list for tile (0,0a mask of 0xF is generated for the primitive list corresponding to tile (1,0), which indicates that all of the primitives in the group (i.e. primitives A, B, C and D) need to be written to the primitive list corresponding to tile (1,0). The primitive list writing circuit then uses this mask to write primitives A, B, C and D to the primitive list corresponding to tile (1,0) together in a single write cycle.

This process is carried out for all six tiles (0,0), (1,0), (2,0), (0,1), (1,1) and (2,1) that are covered by primitives in the group, in order to write all of the primitives in the group to their required primitive lists. It takes six primitive list write cycles in total to write all of the grouped primitives A, B, C and D to their required primitive lists (i.e. one primitive list write cycle for each tile that is iterated over).

Once all of the primitives in the group have been written to their required primitive lists in this manner, the group can be considered “empty”, and a new group is started by primitive E based on its bounding box attributes (2, 0, 3, 1). Data indicating the bounding box for the primitive E (that defines this new group going forward) is stored.

In S5 (506), primitive F is processed. The bounding box for primitive F with attributes (2, 1, 3, 1) is within the allowed offset from the bounding box of primitive E, and so the primitive grouping unit determines that primitive F can be added to the group with primitive. Offset data (00, 01, 00, 00) is stored for primitive F.

In S6 (507), primitive G is processed. The bounding box for primitive G with attributes (2, 1, 2, 1) is within the allowed offset from the bounding box of primitive E, and so the primitive grouping unit determines that primitive F can be added to the group with primitive. Offset data (00, 01, 11, 00) is stored for primitive F.

In S7 (508), primitive H is processed. The bounding box for primitive H with attributes (0, 0, 1, 0) is not within the allowed offset from the bounding box of primitive E, and so the primitive grouping unit determines that primitive H cannot be added to the group with primitives E, F and G. This triggers the writing of the primitives in the group (i.e. primitives E, F and G) to their required primitive lists, using the same process as described above in relation to S4. It takes 4 primitive list write cycles in total to write the grouped primitives (i.e. primitives E, F and G) to the primitive lists for the four tiles (2,0), (3,0), (2,1) and (3,1).

As there are no more primitives in the sequence of primitives to be processed, primitive H is written to its required primitive lists (i.e. the primitive lists corresponding to tiles (0,1), (1,1), (2,1) and (3,1).

FIG. 6 illustrates an embodiment which differs from the embodiments shown in the FIGS. 4 and 5 in that, rather than preparing primitive lists for individual tiles of the render output, primitive lists are prepared for larger regions of the render output wherein each of these larger regions is made up of four tiles. Thus the render output is divided into four such larger regions: region (0,0), which is made up of tiles (0,0), (1,0), (0,1) and (1,1); region (1,0), which is made up of tiles (2,0), (3,0), (2,1) and (3,1); region (0,1), which is made up of tiles (0,2), (1,2), (0,3) and (1,3); and region (1,1) which is made up of tiles (2, 2), (3, 2), (2, 3) and (3, 3)

Thus, In this embodiment, when a primitive is processed, it is determined whether the primitive falls within (i.e. at least partially covers) these larger regions of the render output, and hence bounding boxes determined for primitives to determine what (larger) regions of the render output a primitive at least partially covers are rounded to the size of these larger regions (and the attributes of the bounding boxes are defined in units of lengths of these larger regions).

In this embodiment, it is (only) determined that a primitive can be added to a group (i.e. “grouped”) with previous primitives when the set of regions covered by (the bounding box of) the primitive exactly matches the set of regions covered by (the bounding box of) the previous primitives in the group (with these bounding boxes being rounded to the size of the larger regions of the render output).

However, when a primitive is added to the group, it is stored alongside bounding box offset data for the primitive, wherein the bounding box offset data relates to the offset of the bounding box rounded to the size of the tiles (i.e. the same bounding box offset data that is generated and stored for primitives in the embodiment shown in FIG. 5, described above). These offsets are then used to generate a 4-bit quadrant coverage mask indicating the quadrants of the region that the primitive falls within, which is written to the primitive list alongside the primitive (when the primitive is written to a primitive list). The 4-bit quadrant coverage mask is arranged as follows:
   |0|1|
   |2|3|

The 4 bit coverage mask stored for each primitive in the primitive list may then be used downstream to filter out primitives when rendering the tiles of the render output.

In S0 (601), primitive A is processed by the tiling unit. The primitive grouping unit determines that there is no group available for grouping (i.e. the group is “empty”) and so primitive A starts a new group based on its bounding box with attributes (0, 0, 0, 0). Data indicating the bounding box for the primitive A (that defines the group going forward) is stored, which is used when determining whether subsequent primitives can be added to the group.

In S1 (602), primitive B is processed. The primitive grouping unit determines that the bounding box for primitive B matches that of primitive A and so it is determined that primitive B can be added to the group with primitive A. Primitive B is therefore added to the group with primitive A. Offset data (00, 00, 00, 00) is stored for primitive B (similarly to step 502 described above in relation to the embodiment shown in FIG. 5).

In S2 (603), primitive C is processed. The primitive grouping unit determines that the bounding box for primitive C matches that of primitive A (and primitive B) and so it is determined that primitive C can be added to the group with primitives A and B. Primitive C is therefore added to the group with primitives A and B. Offset data (01, 00, 00, 00) is stored for primitive C (similarly to step 503 above).

In S3 (604), primitive D is processed. The bounding box for primitive D does not match the bounding box for primitive A (or B or C) and so it is determined that primitive D cannot be added to the group with primitives A, B and C.

This triggers the writing of the primitives in the group (i.e. primitives A, B, C and D) together (i.e. in a single primitive list write cycle) to the primitive list corresponding to the (single) region that those primitives cover (i.e. region (0,0)). When writing each primitive to the primitive list for region (0,0), the stored offset data for the primitive is used to generate a four bit coverage mask, indicating the quadrant coverage by the primitive within the region, which is written to the primitive list alongside the primitive. For example, a coverage mask of 0xF is generated for primitive B (indicating that primitive B covers each quadrant (tile) of region (0,0)).

Once all of the primitives in the group (i.e. primitives A, B and C) have been written to the primitive list corresponding to region (0,0) alongside their coverage masks in this manner, the group can be considered “empty”, and a new group is started by primitive D based on its bounding box attributes (0, 0, 1, 0). Data indicating the bounding box for the primitive D (that defines this new group going forward) is stored.

In step S4 (605), primitive E is processed. The bounding box for primitive E does not match the bounding box for primitive D and so it is determined that primitive E cannot be added to the group with primitive D.

This triggers the writing of the primitive D (i.e. the only primitive in the group) to its required primitive lists, i.e. the primitive lists corresponding to regions (0,0) and (1,0), along with the primitive's quadrant coverage mask that is generated for each of those region.

Once this is done, the group can be considered “empty” again, and a new group is started by primitive E based on its bounding box attributes (1, 0, 1, 0). Data indicating the bounding box for the primitive E (that defines this new group going forward) is stored.

In S5 (606), primitive F is processed. The primitive grouping unit determines that the bounding box for primitive F matches that of primitive E and so it is determined that primitive F can be added to the group with primitive E. Primitive B is therefore added to the group with primitive A. Offset data (00, 00, 01, 00) is stored for primitive F (similarly to step 506 above).

In S6 (607), primitive G is processed. The primitive grouping unit determines that the bounding box for primitive G matches that of primitive E and so it is determined that primitive G can be added to the group with primitives E and F. Primitive G is therefore added to the group with primitives E and F. Offset data (00, 01, 11, 00) is stored for primitive F (similarly to step 507 above).

In S7 (608), primitive H is processed. The bounding box for primitive H does not match the bounding box for primitive E and so it is determined that primitive E cannot be added to the group with primitive E, F and G.

This triggers the writing of the primitives in the group (i.e. primitives E, F and G) together (i.e. in a single primitive list write cycle) to the primitive list corresponding to region (1,0). The four bit coverage masks that are generated for primitives E, F and G are written to the primitive list along with those primitives.

As there are no more primitives in the sequence of primitives to be processed, primitive H is written to its required primitive lists (i.e. the primitive lists corresponding to regions (0,0) and (1,0)), along with the primitive's coverage mask that is generated for each of those regions.

It can be seen from the above that the technology described herein, in its embodiments at least, can be used to reduce the overall number of primitive list write cycles (and hence overall processing power) required to write primitives to primitive lists.

This is achieved, in the embodiments at least, by grouping primitives before writing them to their required primitive lists, and writing the grouped primitives together to one or more primitive lists (i.e. such that multiple primitives are written together to one or more primitive lists in a single primitive list write cycle).

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a tile-based graphics processing system in which a render output is sub-divided into a plurality of tiles for rendering, and in which primitives in a sequence of primitives to be processed are written to primitive lists corresponding to respective regions of the render output, the method comprising:
before writing a primitive to a primitive list, first determining whether the primitive can be grouped with one or more previous primitives in the sequence of primitives, for the purpose of being written to one or more primitive lists;
when it is determined that the primitive can be grouped with one or more previous primitives, grouping the primitive with the one or more previous primitives; and thereafter:
writing grouped primitives together to one or more primitive lists.

2. The method of claim 1, further comprising:
when it is determined that the primitive cannot be grouped with one or more previous primitives, triggering writing one or more previous primitives together to one or more primitive lists without grouping the primitive with one or more previous primitives.

3. The method of claim 1, wherein the step of writing grouped primitives together to one or more primitive lists comprises:
for each of the one or more regions covered by the grouped primitives writing to the primitive list corresponding to that region all of the grouped primitives that cover that region in a single primitive list write cycle.

4. The method of claim 1, further comprising determining whether the primitive can be grouped with one or more previous primitives based on the set of regions covered by the primitive relative to the set of regions covered by one or more previous primitives.

5. The method of claim 4, wherein it is determined that the primitive can be grouped with one or more previous primitives when the primitive is determined to cover a set of regions of render output that exactly matches the set of regions covered by one or more previous primitives.

6. The method of claim 4, wherein it is determined that the primitive can be grouped with one or more primitives when the primitive is determined to cover a set of regions that is sufficiently similar or overlapping with a set of regions covered by one or more previous primitives.

7. The method of claim 6, wherein it is determined that the primitive can be grouped with one or more previous primitives when a determined bounding box for the primitive is offset from a determined bounding box for a previous primitive, within an offset threshold, and wherein the method further comprises:
when grouping the primitive with the one or more previous primitives, storing bounding box offset data for the primitive; and
using the stored bounding box offset data when writing grouped primitives together to one or more primitive lists.

8. The method of claim 1, wherein the step of writing grouped primitives together to one or more primitive lists is triggered by the number of grouped primitives reaching a threshold.

9. A tile-based graphics processing system in which a render output is sub-divided into a plurality of tiles for rendering, and comprising a tiling circuit configured to write primitives in a sequence of primitives to be processed to primitive lists corresponding to respective regions of the render output, wherein the tiling circuit comprises:
a primitive grouping circuit configured to:
before the primitive is written to a primitive list, first determine whether the primitive can be grouped with one or more previous primitives in the sequence of primitives, for the purposes of being written to one or more primitive lists; and
when it is determined that the primitive can be grouped with one or more previous primitives, group the primitive with the one or more previous primitives; and
a primitive list writing circuit configured to write grouped primitives together to one or more primitive lists.

10. The tile-based graphics processing system of claim 9, wherein the primitive grouping circuit is configured to:
when it is determined that a primitive cannot be grouped with one or more previous primitives, trigger writing one or more previous primitives together to one or more primitive lists without grouping the primitive with one or more previous primitives.

11. The tile-based graphics processing system of claim 9, wherein the primitive list writing circuit is configured to write grouped primitives together to one or more primitive lists by:
for each of the one or more regions covered by the grouped primitives writing to the primitive list corresponding to that region all of the grouped primitives that cover that region in a single primitive list write cycle.

12. The tile-based graphics processing system of claim 9, wherein the primitive grouping circuit is configured to determine whether a primitive can be grouped with one or more previous primitives based on the set of regions covered by the primitive relative to the set of regions covered by one or more previous primitives.

13. The tile-based graphics processing system of claim 12, wherein the primitive grouping circuit is configured to determine that a primitive can be grouped with one or more previous primitives when the primitive is determined to cover a set of regions of render output that exactly matches the set of regions covered by one or more previous primitives.

14. The tile-based graphics processing system of claim 12, wherein the primitive grouping circuit is configured to determine that a primitive can be grouped with one or more primitives when the primitive is determined to cover a set of regions that is sufficiently similar or overlapping with a set of regions covered by one or more previous primitives.

15. The tile-based graphics processing system of claim 14, wherein the primitive grouping circuit is configured to:
determine that a that the primitive can be grouped with one or more previous primitives when a determined bounding box for the primitive is offset from a determined bounding box for a previous primitive, within an offset threshold; and
when grouping the primitive with the one or more previous primitives, store bounding box offset data for the primitive;
and wherein the primitive list writing circuit is configured to use the stored bounding box offset data when writing grouped primitives together to one or more primitive lists.

16. The tile-based graphics processing system of claim 9, wherein the a primitive list writing circuit is configured to be triggered to write grouped primitives together to one or more primitive lists when the number of grouped primitives reaches a threshold.

17. A non-transitory computer readable storage medium storing instructions which, when the instructions are executed by a processor, cause the processor to carry out a method of operating a tile-based graphics processing system in which a render output is sub-divided into a plurality of tiles for rendering, and in which primitives in a sequence of primitives to be processed are written to primitive lists corresponding to respective regions of the render output, the method comprising:
before writing a primitive to a primitive list, first determining whether the primitive can be grouped with one or more previous primitives in the sequence of primitives, for the purpose of being written to one or more primitive lists;
when it is determined that the primitive can be grouped with one or more previous primitives, grouping the primitive with the one or more previous primitives; and thereafter:
writing grouped primitives together to one or more primitive lists.
